(19) United States
(12) Patent Application Publication
(10) Pub. No.: US 2020/0283574 A1
(43) Pub. Date: Sep. 10, 2020

(54) CROSSLINKABLE FLUORINATED POLY(ARYLENE ETHER)

(71) Applicant: SOLVAY SPECIALTY POLYMERS ITALY S.P.A., Bollate (IT)

(72) Inventors: Ritu AHUJA, Singapore (SG); Valeriy KAPELYUSHKO, Alessandria (IT); Gajanan Manohar PAWAR, Vadodara (IN); Stefano MILLEFANTI, Tradate (IT); Mattia BASSI, Milano (IT)

(21) Appl. No.: 16/644,495

(22) PCT Filed: Aug. 31, 2018
(86) PCT No.: PCT/EP2018/073433

§ 371 Date: Mar. 4, 2020

(30) Foreign Application Priority Data
Sep. 4, 2017 (IN) 201721031303
Oct. 31, 2017 (EP) 17199298.5

(51) Int. Cl. C08G 65/40; C08G 65/48

(52) U.S. Cl. CPC C08G 65/4025; C08G 2650/40; C08G 65/4043; C08G 65/48

(57) ABSTRACT

The present invention relates to modified fluorinated poly(arylene ether ketone)s that can be crosslinked to produce high performance thermoset useful for semiconductor application with low dielectric constant. The present invention also relates to a method for manufacturing said modified fluorinated poly(arylene ether ketone)s prepared via chemical transformation of carbonyl groups to hydroxyl pendant groups and following thermal curing.

### CROSS-REFERENCE TO RELATED APPLICATIONS

This application claims priority to Indian provisional patent application No. 201721031303 filed on 4 Sep. 2017 and to European application No. 17199298.5 filed on 31 Oct. 2017, the whole content of those applications being incorporated herein by reference for all purposes.

### TECHNICAL FIELD

The present invention relates to modified fluorinated poly(arylene ether ketone)s that can be crosslinked to produce high performance thermosets useful for semiconductor application with low dielectric constant.

The present invention also relates to a method for manufacturing said modified fluorinated poly(arylene ether ketone)s prepared via chemical transformation of carbonyl groups to hydroxyl groups and following thermal curing.

### BACKGROUND ART

The electronic industry has recently sought materials with low dielectric constant and dielectric loss, for use as in electronic devices.

Several approaches can be found in the literature to reduce the dielectric constant of materials. Among those, introducing fluorine and free volumes in the material are methods known in the art to enhance electronic properties. In particular, fluorine is widely utilized for reducing dielectric constant of materials because it can reduce the strength of dipoles. On the other side, crosslinking is known to offer free volumes in the system and increasing free volumes in the system means decreasing number of dipoles to minimize dielectric constant. Thus, various polymers have been proposed and utilized as dielectric materials, wherein such polymeric materials include crosslinked poly(arylene ether)s.

Patent document U.S. Pat. No. 5,179,188 (RAYCHEM CORPORATION) Dec. 1, 1993, discloses fluorinated poly(arylene ether) compositions having reactive end groups, such as nitriles, allyl, allylphenyl or N-phenylmaleimido, which can be crosslinked to produce cured films useful as dielectrics for microelectronic applications.

U.S. Pat. No. 5,658,994 (AIR PRODUCTS AND CHEMICALS INC.) Sep. 5, 2000, discloses the utility of poly(arylene ether)s as low dielectric interlayers for the electronics industry where the poly(arylene ether) may be crosslinked either by crosslinking itself, through exposure to temperatures of greater than approximately 350° C., or by providing a crosslinking agent as well as end capping the polymer with known end cap agents, such as phenylethynyl, benzocyclobutene, ethynyl and nitrile.

US2005/0240002 (AIR PRODUCTS AND CHEMICALS INC.) 27 Oct. 2005, discloses poly(arylene ether) polymers including recurring units adapted to crosslink at relatively low temperatures, at or below 300° C., that meets the mechanical property requirements of electronics and display industries.

It would be advantageous to have poly(arylene ether) polymers having improved thermal and mechanical properties and low dielectric constant that can be prepared by a simple process and also cures at relatively low temperatures.

### SUMMARY OF INVENTION

The Applicant has now surprisingly found that certain modified fluorinated poly(arylene ether ketone) polymers can be self-crosslinked to produce cured films that are particularly suitable for use in many applications in dielectric utilities because offer low dielectric constant and are easy to prepare, with crosslinking temperature being at or below 300° C. In said polymers the beneficial advantages of introducing fluorine and free volumes in the material are obtained without the need to include further functionalities for curing.

The present invention hence is directed, in a first aspect, to a hydroxylated fluorinated poly(arylene ether ketone) [F-PAEK-OH] comprising a total number of recurring units comprised between 2 and 400, wherein at least 1% moles of the recurring units have formula (I)

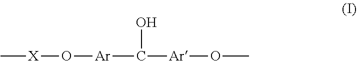

the remaining being recurring units of formula (R_{F-PAEK})

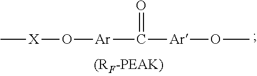

with Ar and Ar′, equal to or different from each other, being aromatic moieties comprising at least one aromatic mono- or poly-nuclear cycle, X is a bisphenol moiety of formula:

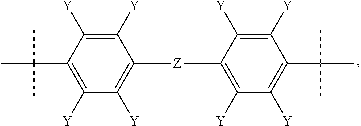

wherein Y is hydrogen or fluorine and Z is an alkylic or aromatic fluorinated moiety, the sum of recurring units (I) and (R_{F-PAEK}) being 100% moles.

The invention further pertains to a method for manufacturing the F-PAEK-OH as above detailed, said method comprising:
(i) providing a fluorinated poly(arylene ether ketone) [F-PAEK] of formula (II)

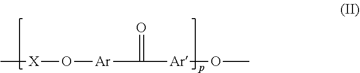

wherein p is an integer of from 2 to 400, X, Ar and Ar′ are as above defined;
(ii) reducing the carbonyl groups of F-PAEK of formula (II) to hydroxyl groups with at least one reducing agent.

The Applicant found that, advantageously, the F-PAEK-OH obtained by the reduction of at least a portion of the carbonyl groups of F-PAEK can be directly thermally crosslinked to get thermoset material without the addition of any other reagent.

In a further aspect, thus, the present invention relates to a thermoset material obtainable by crosslinking the F-PAEK-OH [F-PAEK-based thermoset] and to articles comprising said F-PAEK-based thermoset.

### DESCRIPTION OF EMBODIMENTS

In the context of the present invention, the use of parentheses “( . . . )” before and after symbols or numbers identifying formulae or parts of formulae has the mere purpose of better distinguishing that symbol or number with respect to the rest of the text; thus, said parentheses could also be omitted.

F-PAEK

For the purpose of the invention, the term “fluorinated poly(arylene ether ketone) [F-PAEK]” is intended to denote any polymer comprising recurring units (R_{F-PAEK}) comprising a X—O—Ar—C(O)—Ar′ group.

The aromatic moieties Ar and Ar′, equal to or different from each other, are aromatic moieties comprising at least one aromatic mono- or poly-nuclear cycle, such as a phenylene or a naphthylene group. The at least one aromatic mono- or poly-nuclear cycle may optionally be substituted with at least one substituent selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium.

In a preferred embodiment Ar and Ar′ are equal to each other and are phenylene groups or naphthylene groups.

Preferably, the bisphenol moiety X as above defined includes an alkylic or aromatic fluorinated moiety Z.

The term “alkylic fluorinated moiety” is intended to refer to linear, branched or cyclic hydrocarbon chain in which some or all of the hydrogen atoms may be replaced with fluorine atoms, wherein said chain may be optionally unsaturated and wherein one or more carbon atoms may be replaced by heteroatom(s) such as 0 or S, preferably 0.

The term “aromatic fluorinated moiety” refers to a radical derived from an aromatic system having 6 to 18 carbon atoms including, but not limited to, phenyl, biphenyl, naphthyl, anthracenyl and the like, in which some or all of the hydrogen atoms are replaced with one or more of a fluorine atom and a —CF₃ group.

In the context of the present application, the terms “alkylic fluorinated moiety” and “aromatic fluorinated moiety” may include fluorinated alkylic and aromatic fluorinated moieties that are optionally substituted with at least one group selected from the following: halogen, alkyl, alkenyl, alkynyl, aryl, ether, thioether, carboxylic acid, ester, amide, imide.

F-PAEK polymers suitable for use in the present invention can be homopolymers, thus comprising essentially a single repeating unit (R_{F}—PAEK), or copolymers such as random, alternate or block copolymer.

When the F-PAEK polymer is a copolymer, it may notably contain at least two different recurring units (R_{F-PAEK}) including X, Ar and Ar′ moieties having different meanings among those above defined.

Preferably, F-PAEK polymer is a homopolymer.

The F-PAEK of formula (II) can be prepared by polycondensation of a bisphenol of formula (A):

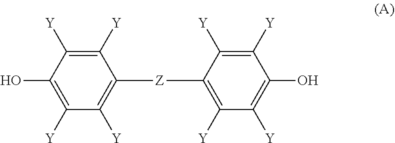

wherein Y is hydrogen or fluorine and Z is an alkylic or aromatic fluorinated moiety,

with a compound of formula (B):

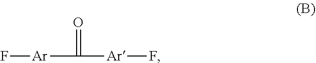

with Ar and Ar′ being as above defined.

Preferably, in the polycondensation the molar ratio of reactants (B) and (A) is in the range of from about 0.9 to about 1.1, more preferably it is about 1.02.

In a preferred embodiment, the F-PAEK used in the present invention has a number average molecular weight Mn comprised between 4000 and 50000, preferably between 7000 and 20000, more preferably between 8000 and 15000, and a weight average molecular weight MW comprised between 20000 and 300000, preferably between 30000 and 200000.

The alkylic fluorinated moiety Z in the bisphenols of formula (A) is preferably selected from the group consisting of:

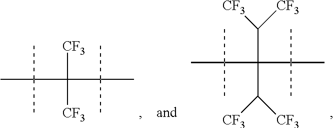

The aromatic fluorinated moiety Z in the bisphenols of formula (A) is preferably selected from the group consisting of:

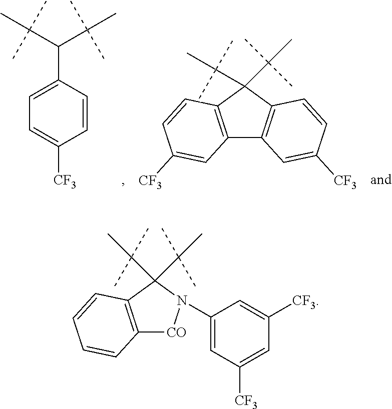

In a preferred embodiment Ar and Ar′ are equal to each other and are phenylene groups.

In a preferred embodiment, the F-PAEK of formula (II) is the compound of formula:

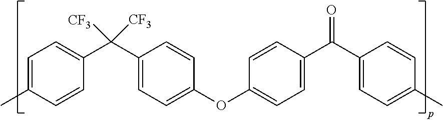

wherein p is an integer of from 2 to 400.

Hydroxylated Fluorinated Poly(Arylene Ether Ketone) [F-PAEK-OH]

The F-PAEK-OH of the present invention can be fully reduced or partially reduced.

As used within the present invention, the term F-PAEK-OH is intended to include both partially reduced F-PAEK-OH and fully reduced F-PAEK-OH, unless otherwise specified.

For the purpose of the present invention, by the term “fully reduced” it is meant that all the carbonyl groups of the F-PAEK of formula (II) have been reduced to hydroxyl groups to obtain a F-PAEK-OH wherein 100% of recurring units are recurring units of formula (I).

The instance in which less than 100% of recurring units are recurring units of formula (I) corresponds to partially reduced F-PAEK-OH, wherein by the term “partially reduced” it is meant that the reduction of F-PAEK of formula (II) has not been completed, and F-PAEK-OH still includes at least a portion of carbonyl groups which has not been converted to hydroxyl groups.

In a preferred embodiment, in F-PAEK-OH of the present invention comprises at least 10% by moles, more preferably at least 40% by moles, still more preferably at least 60% by moles, of recurring units of formula (I).

In a preferred embodiment, in F-PAEK-OH of the present invention, X is notably selected from the group consisting of:

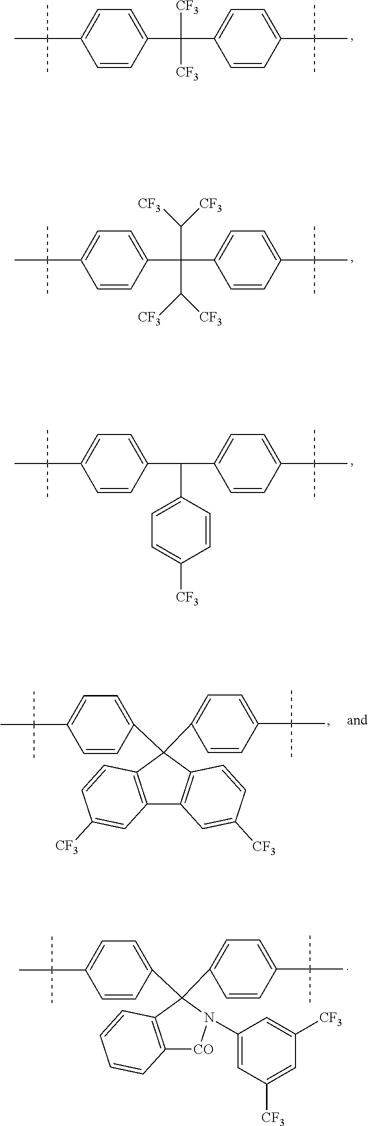

In a preferred embodiment, F-PAEK-OH is the compound of formula:

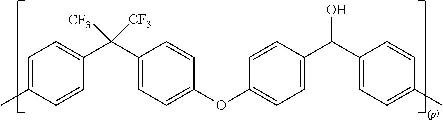

wherein p is an integer of from 1 to 400.

Additives can be used to enhance or impart particular target properties to F-PAEK-OH, as it is conventionally known in the polymer art, including stabilizers, flame retardants, pigments, plasticizers, surfactants and the like.

The invention further pertains to a method for manufacturing the F-PAEK-OH as above detailed, said method comprising:
(i) providing a fluorinated poly(arylene ether ketone) [F-PAEK] of formula (II)

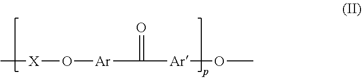

wherein p is an integer of from 1 to 400;
Ar and Ar′, equal to or different from each other, are aromatic moieties comprising at least one aromatic mono- or poly-nuclear cycle;
X is a bisphenol moiety of formula:

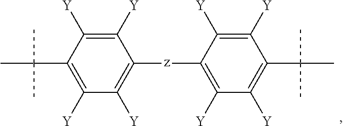

wherein Y is hydrogen or fluorine; and
Z is an alkylic or aromatic fluorinated moiety; and
(ii) reducing the carbonyl groups of F-PAEK of formula (II) to hydroxyl groups with at least one reducing agent.

Reduction step (ii) can be carried out according to procedures known in the art.

In principle, any agent that is capable of converting carbonyl groups to hydroxyl groups can be used in step (ii). Borohydrides are particularly preferred. Such borohydrides include, but are not limited to, sodium borohydride, potassium borohydride, lithium borohydride, sodium cyanoborohydride, sodium triacetoxyborohydride, sodium trimethoxyborohydride, tetramethylammonium borohydride, tetramethylammonium triacetoxyborohydride, tetraethylammonium borohydride, tetrabutylammonium borohydride, tetrabutylammonium cyanoborohydride, cetyltrimethylammonium borohydride, benzyltriethylammonium borohydride, bis(triphenyl-phosphine) copper(I) borohydride, lithium aluminium hydride, dimethylamineborane (DMAB) and mixtures of at least two of these. Preferably, said reducing agent is sodium borohydride.

For the purpose of the present invention, reduction step (ii) can be a partial reduction or a complete reduction, leading, respectively, to a partially or fully reduced F-PAEK-OH as defined above.

By the term “effective amount of at least one reducing agent capable of converting carbonyl groups of the F-PAEK to hydroxyl groups” as used herein it is meant an amount of reducing agent sufficient to cause at least the partial reduction preferably the complete reduction, of the carbonyl groups of the F-PAEK of formula (II).

Advantageously, the amount of the at least one reducing agent capable of converting carbonyl groups of the F-PAEK to hydroxyl groups is within the range of from 2 to 6 equivalents of reducing agent per equivalent of F-PAEK.

The extent of the reduction of the F-PAEK to F-PAEK-OH may be followed by IR technique, analysing the intensity of the peak related to the carbonyl groups, which decreases with time indicating the conversion to hydroxyl groups. It may also be followed by nuclear magnetic resonance, ¹H-NMR, ¹³C-NMR and ¹⁹F-NMR, dissolving the samples in chloroform.

The duration of step (ii) is usually comprised between 10 minutes and 12 hours, preferably from 20 minutes to 5 hours.

The temperature in step (ii) may range from room temperature to about 150° C.

The F-PAEK-OH obtained by the method according to the present invention is preferably in the form of powder.

F-PAEK-OH of the present invention can be formed in the form of a film.

Thus, another object of the present invention is a film of F-PAEK-OH.

Films of F-PAEK-OH can be manufactured by solution techniques such as spraying, spin coating, bar coating or casting, with bar coating being preferred. Preferred solvents for the F-PAEK-OH include chloroform, dichloromethane, tetrahydrofuran, cyclopentanone and cyclohexanone

Typically, the film thickness of films of F-PAEK-OH of the present invention is comprised between 10 and 20 micron.

The Applicant found that, advantageously, the F-PAEK-OH obtained by the reduction of at least a portion of the carbonyl groups of F-PAEK can be directly thermally crosslinked to get thermoset material without the addition of any other reagent, due to self-condensation of the polymer backbone.

Thermal crosslinking can be carried out on F-PAEK-OH in the form of powder or on films of F-PAEK-OH, preferably on films.

In a further object, thus, the present invention provides a method to obtain a thermoset material [F-PAEK-based thermoset] by thermally crosslinking a F-PAEK-OH.

For the purpose of the present invention, the term “thermal crosslinking”, is hereby intended to denote heating the F-PAEK-OH at a temperature and for a time sufficient to obtain self-crosslinking within the polymer, without the need for any additional reagent.

Heating temperatures for the thermal crosslinking of the F-PAEK-OH of the present invention may vary from about 150° C. to about 300° C.

Heating times can be a function of temperature. Suitable heating times may vary from less than one hour to about 10 hours.

For the purpose of the present invention, the term “thermoset material” when used in connection with the product of the thermal crosslinking of F-PAEK-OH is hereby intended to denote crosslinked material particularly suitable for use in many applications in dielectric utilities.

The crosslinking can be verified by solubility tests on films of the F-PAEK-based thermoset at the end of the heating. Solubility of cured films of F-PAEK-based thermoset films can be studied in different types of solvent: the absence of solubilization in said solvents is the confirmation of crosslinking.

The F-PAEK-based thermoset of the present invention advantageously shows improved thermal and mechanical properties and low dielectric constant and has the additional advantage of being prepared by a simple process including curing at relatively low temperatures.

In a further aspect, thus, the present invention relates to articles comprising a F-PAEK-based thermoset.

The F-PAEK-based thermoset of the present invention have wide application in, for example, chemical, electronic and semiconductor industries. The F-PAEK-based thermoset is also suitable for coating surfaces and for fabricating O-rings, V-rings, gaskets and diaphragms.

Should the disclosure of any patents, patent applications, and publications which are incorporated herein by reference conflict with the description of the present application to the extent that it may render a term unclear, the present description shall take precedence.

The invention will be now described in more details with reference to the following examples whose purpose is merely illustrative and not limitative of the scope of the invention.

Raw Materials:

All starting materials received from commercial source and used as such without any further purification.

Thermal Analyses

Polymer thermal stability (TGA) was tested using Q500—TA instruments in N₂ atmosphere with heating rate 20° C./min.

DSC measurements were performed on a Q2000—TA instruments in N₂ atmosphere.

### Example 1

Synthesis of F-PAEK:

2,2-Bis(4-hydroxyphenyl)hexafluoropropan (65.0 g, 0.193 moles), difluorobenzophenone (43.0 g, 0.197 moles) and K2003 (40.0 g, 0.290 moles), NMP (400 mL) and toluene (200 mL) were charged in the three neck round bottom flask equipped with condenser, mechanical stirrer and nitrogen inlet. The reaction mixture was heated at 140-150° C. with stirring under a nitrogen atmosphere and reaction was monitored by GPC analysis. Once the desired molecular weight was achieved, reaction mixture was precipitated in water and polymer lumps were thoroughly washed with hot water. For further purification, polymer was dissolved in CH₂Cl₂ and precipitated in methanol, and then dried under the vacuum at 130° C. for overnight.

% Yield: >95%

# GPC: Mn: 9784, MW: 52610, PDI: 5.0

# ¹H NMR (CDCl₃): 7.05-7.10 (q, 8H, J=8 Hz), 7.38-7.40 (d, 4H, J=8 Hz), 7.81-7.83 (d, 4H, J=8 Hz).

### Example 2

F-PAEK Reduction:

F-PAEK powder obtained as described in example 1 (25.0 g, 0.058 moles, 1 eq.), sodium borohydride (6.68 g, 0.177 moles, 3 Eq.) and THF (200 ml) were charged in the three neck round bottom flask equipped with condenser and nitrogen inlet. The reaction mixture was heated at 60° C. for 20 min to 1 h and reaction was monitored by FT-IR spectroscopy. After reaching required conversion, reaction mass was cooled to the room temperature and precipitated in methanol. Powder was washed with fresh methanol (100 ml) for 15 min, in DM water for 15 min, in 0.5 N HCl for 10 min, in water for 10 min, and in methanol for 20 min. Finally, the powder was dried at 100° C. under vacuum for 30 min to obtain 25.0 g—of partially reduced F-PAEK-OH (60% conversion).

% Yield: 95%

# GPC: Mn: 8646, MW: 42452, PDI: 4.9

# ¹H NMR (CDCl₃): 5.86 (s, 1H), 6.95-6.97 (d, 4H, J=8 Hz), 7.04-7.06 (d, 4H, J=8 Hz), 7.34-7.45 (m, 8H).

### Example 3

F-PAEK-OH Film Preparation:

F-PAEK-OH powder (10 g) obtained in example 2 was dissolved in chloroform (30 g) and a film was prepared by using a bar coater. The film was dried under vacuum at 50-100° C. and examined for residual solvent.

### Example 4

Curing of F-PAEK-OH:

F-PAEK-OH film obtained in example 3 was thermally cured by heating at 200° C. for 5 h.

TGA of F-PAEK-OH:

Thermal stability of F-PAEK-OH was studied by thermogravimetric analysis (TGA) under N₂ atmosphere (40 mL/min) at 20° C./min heating rate. As shown in Table 1, the thermal stability of F-PAEK-OH was slightly reduced (˜15° C.) as compared to the starting F-PAEK (reduction time 0 min).

TABLE 1

| Reduction | Thermal Stability |
|---|---|
| time | (10% weight loss) |
| 0 min | 531° C. |
| 30 min | 527° C. |
| 60 min | 515° C. |
| 180 min | 514° C. |

DSC of F-PAEK-OH

Thermal analysis of the F-PAEK-OH was performed by differential scanning calorimetry (DSC) under N₂ atmosphere (40 mL/min) at 20° C./min heating rate. As shown in Table 2 below, the glass transition temperature (Tg) of F-PAEK-OH was increased as compared to the starting F-PAEK. Increase in Tg of F-PAEK-OH is related to the percentage of reduction, means the conversion of carbonyl groups into hydroxyl groups and also heating time.

TABLE 2

| | Tg |
|---|---|
| Polymer | (second heating cycle) |
| F-PAEK | 162° C. |
| Partially reduced | 170° C. |
| F-PAEK-OH | |
| Fully reduced | 180° C. |
| F-PAEK-OH | |

Solubility Test of Cured F-PAEK-Based Thermoset Films

Solubility of cured films of F-PAEK-based thermoset films was studied in different types of solvent to confirm the crosslinking of polymer. Thermally cured films were found to be swelled in dichloromethane, tetrahydrofuran, dimethylformamide and toluene but did not dissolve in any of the solvents.

Mechanical Properties of F-PAEK-Based Thermoset Films

Mechanical properties of cured F-PAEK-based thermoset films and non-cured F-PAEK-OH films were measured on a Instron 5500 R (Bluehill 2) at 23° C.

The results are shown in Table 3.

TABLE 3

| | | Yield | Yield | | | Stress | Strain |
|---|---|---|---|---|---|---|---|
| | | Stress | Strain | 1^{st} Yield | 1^{st} Yield | at | at |
| | Modulus | offset 1% | offset 1% | Stress | Strain | Break | Break |
| | (MPa) | (MPa) | (%) | (MPa) | (%) | (MPa) | (%) |
| Film 1: | 2281 ± 107 | 50.3 ± 1.6 | 3.2 ± 0.0 | 39.8 ± 2.1 | 1.9 ± 0.2 | 44.9 ± 2.3 | 6 ± 2 |
| F-PAEK-OH | | | | | | | |
| Film 2: | 2148 ± 253 | 62.1 ± 8.0 | 3.9 ± 0.0 | 54.4 ± 3.4 | 3.0 ± 0.5 | 66.9 ± 3.1 | 5 ± 2 |
| F-PAEK- | | | | | | | |
| based | | | | | | | |
| thermoset | | | | | | | |

1. A hydroxylated fluorinated poly(arylene ether ketone) [F-PAEK-OH] comprising a total number of recurring units comprised between 2 and 400, wherein at least 1% moles of the recurring units have formula (I) 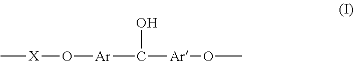
the remaining being recurring units of formula (R_{F-PAEK}) 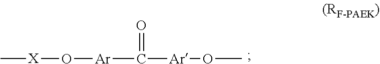
with Ar and Ar′, equal to or different from each other, being aromatic moieties comprising at least one aromatic mono- or poly-nuclear cycle,
X is a bisphenol moiety of formula: 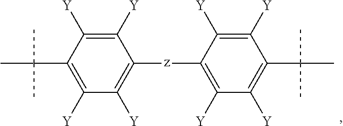
wherein Y is hydrogen or fluorine and Z is an alkylic or aromatic fluorinated moiety, the sum of recurring units (I) and (R_{F-PAEK}) being 100% moles.

2. The F-PAEK-OH according to claim 1 wherein at least 10% by moles of the recurring units have formula (I).

3. The F-PAEK-OH according to claim 1 wherein Z is an alkylic fluorinated moiety selected from the group consisting of:

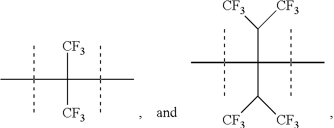

4. The F-PAEK-OH according to claim 1 wherein Z is an aromatic fluorinated moiety selected from the group consisting of:

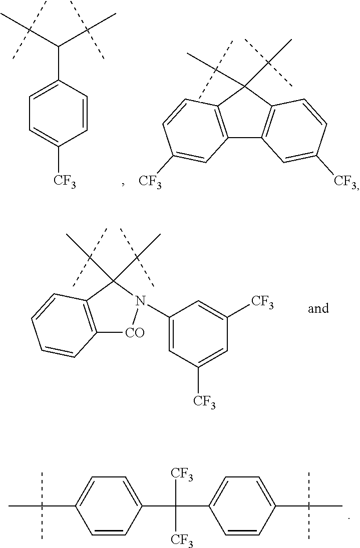

5. The F-PAEK-OH according to claim 1 wherein Ar and Ar′, equal to or different from each other, are phenylene or naphthylene groups.

6. The F-PAEK-OH according to claim 1 which has formula: 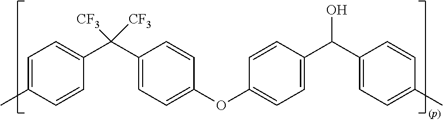
wherein p is an integer of from 1 to 400.

7. The F-PAEK-OH according to claim 1 which is in the form of powder or in the form of a film.

8. A method for manufacturing the F-PAEK-OH of claim 1, said method comprising:
reducing carbonyl groups of a fluorinated poly(arylene ether ketone) [F-PAEK] of formula (II) to hydroxyl groups with at least one reducing agent: 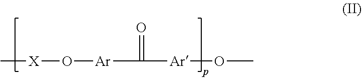
wherein p is an integer of from 1 to 400;
Ar and Ar′, equal to or different from each other, being aromatic moieties comprising at least one aromatic mono- or poly-nuclear cycle; X is a bisphenol moiety of formula: 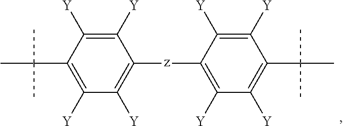
wherein Y is hydrogen or fluorine; and
Z is an alkylic or aromatic fluorinated moiety.

9. The method according to claim 8 wherein the amount of at least one reducing agent is within the range of from 2 to 6 equivalents of reducing agent per equivalent of F-PAEK.

10. The method according to claim 8 wherein the F-PAEK has a number average molecular weight Mn comprised between 4000 and 50000 and a weight average molecular weight MW comprised between 20000 and 300000.

11. The method according to claim 8 wherein the F-PAEK is the compound of formula 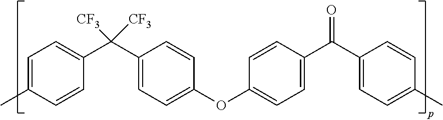
wherein p is an integer of from 1 to 400.

12. The method according to claim 8 wherein the at least one reducing agent capable of converting carbonyl groups of the F-PAEK to hydroxyl groups is a borohydride.

13. A method to prepare a thermoset material [F-PAEK-based thermoset], said method comprising thermally crosslinking a F-PAEK-OH according to claim 1.

14. The method according to claim 13 wherein said thermally crosslinking is performed at heating temperature from about 150° C. to about 300° C.

15. A thermoset material [F-PAEK-based thermoset] comprising at least one thermally crosslinked F PAEK-OH according to claim 1.

16. An article comprising the F-PAEK-based thermoset according to claim 15.

17. The F-PAEK-OH according to claim 2 wherein at least 40% by moles of the recurring units have formula (I).

18. The F-PAEK-OH according to claim 6 which is in the form of powder or in the form of a film.

19. The method according to claim 10 wherein the F-PAEK has a number average molecular weight Mn comprised between 7000 and 20000 and a weight average molecular weight MW comprised between 30000 and 200000.

20. The method according to claim 12 wherein the at least one reducing agent capable of converting carbonyl groups of the F-PAEK to hydroxyl groups is sodium borohydride.
